(19) United States
(12) Patent Application Publication
(10) Pub. No.: US 2023/0229473 A1
(43) Pub. Date: Jul. 20, 2023

(54) ADAPTIVE IDLING OF VIRTUAL CENTRAL PROCESSING UNIT

(71) Applicant: VMware, Inc., Palo Alto, CA (US)

(72) Inventors: Timothy MERRIFIELD, Austin, TX (US); Prashant Singh CHOUHAN, Boston, MA (US)

(21) Appl. No.: 17/578,365

(22) Filed: Jan. 18, 2022

(51) Int. Cl. G06F 9/455

(52) U.S. Cl. CPC G06F 9/45558; G06F 2009/45575

(57) ABSTRACT

The performance of a computer system having a virtual machine executing an idling instruction therein is improved by: determining a state for controlling the execution of the idling instruction for a first virtual CPU; when the controlling state is a first state, executing the idling instruction natively in a physical CPU assigned to the first virtual CPU and resuming execution of instructions by the first virtual CPU when the physical CPU wakes up; and when the controlling state is a second state, emulating execution of the idling instruction, the emulated execution including the steps of configuring a wakeup event, descheduling the first virtual CPU, and selecting a second virtual CPU to resume execution of instructions, and in response to the wakeup event, rescheduling the second virtual CPU, performing a task switch from the first to the second virtual CPU, and resuming execution of instructions by the second virtual CPU.

### BACKGROUND

Processors execute several special instructions, including the monitor instruction and the monitor wait (mwait) instruction. The monitor instruction arms an address range of memory for specific events. The mwait instruction transitions the processor into an optimized state, in which state the processor waits for an event or store operation to occur in the address range armed by the monitor instruction. Upon receiving the event or store operation, the processor, which transitioned into the optimized state pursuant to the mwait instruction, executes the instruction following the mwait instruction.

Operating systems, such as Linux®, use monitor and mwait instructions in an idle loop, which is executed on the processor when there is no runnable task available to be scheduled to run thereon. These operating systems may also use the monitor and mwait instructions for thread synchronization and possibly to control the amount of power consumed by the processor.

In a virtualized computer system, an mwait instruction may be executed in the guest operating system (such as the Linux® operating system) of a virtual machine (VM), and the virtualization software of the computer system must decide how to permit the execution of the mwait instruction.

### SUMMARY

One or more embodiments improve the performance of a computer system having a virtual machine running therein and executing an idling instruction. The method of improving the performance of such a computer system includes: determining a state for controlling the execution of the idling instruction for a first virtual CPU; when the controlling state is a first state, executing the idling instruction natively in a physical CPU assigned to the first virtual CPU and resuming execution of instructions after the idling instruction by the first virtual CPU when the physical CPU wakes up; and when the controlling state is a second state, emulating execution of the idling instruction, the emulated execution including the steps of configuring a wake-up event, descheduling the first virtual CPU, and selecting a second virtual CPU to resume execution of the instructions after the idling instruction, and in response to the wake-up event, rescheduling the second virtual CPU, performing a task switch from the first virtual CPU to the second virtual CPU, and resuming execution of the instructions after the idling instruction by the second virtual CPU.

Further embodiments include a computer-readable medium configured to carry out one or more aspects of the above method and a computer system configured to carry out one or more aspects of the above method.

### BRIEF DESCRIPTION OF DRAWINGS

FIG. 1A depicts a block diagram of a computer system that is representative of a virtualized computer architecture in which embodiments may be implemented.

FIG. 1B is a conceptual diagram that depicts updates made to a run queue maintained by a kernel of the computer system for a particular physical CPU, according to an embodiment.

FIG. 2 depicts a state diagram illustrating different controlling states for executing an idling instruction and transitions among them, according to an embodiment.

FIG. 3 depicts a flow of operations of the monitor when the controlling state is a learning state, according to an embodiment.

FIG. 4 depicts a flow of operations of the monitor when the controlling state is a throughput state, according to an embodiment.

FIG. 5 depicts a flow of operations of the kernel when the controlling state is the throughput state, according to an embodiment.

FIG. 6 depicts a flow of operations of a virtual CPU when the controlling state is a performance state, according to an embodiment.

FIG. 7 depicts graphically the execution of an idling instruction when the controlling state is the performance state.

FIG. 8 depicts graphically the execution of an idling instruction when the controlling state is the learning state.

FIG. 9 depicts graphically the execution of an idling instruction when the controlling state is the throughput state.

FIG. 10 depicts a flow of operations for transitioning from the learning state to the performance state or throughput state, according to an embodiment.

FIG. 11 depicts a flow of operations for transitioning from the throughput state to the performance state, according to an embodiment.

FIG. 12 depicts a flow of operations for transitioning from the performance state to the learning state and optionally to the throughput state, according to an embodiment.

### DETAILED DESCRIPTION

One or more embodiments improve the performance of a computer system having a virtual machine that is executing an idling instruction, e.g., mwait instruction, by adaptively executing the idling instruction according to one of several controlling states. The controlling states include the performance state that improves wake-up latency, the throughput state that improves CPU resource usage, and the learning state during which data about the execution of the mwait instruction, which are used in determining transitions between the controlling states, are collected.

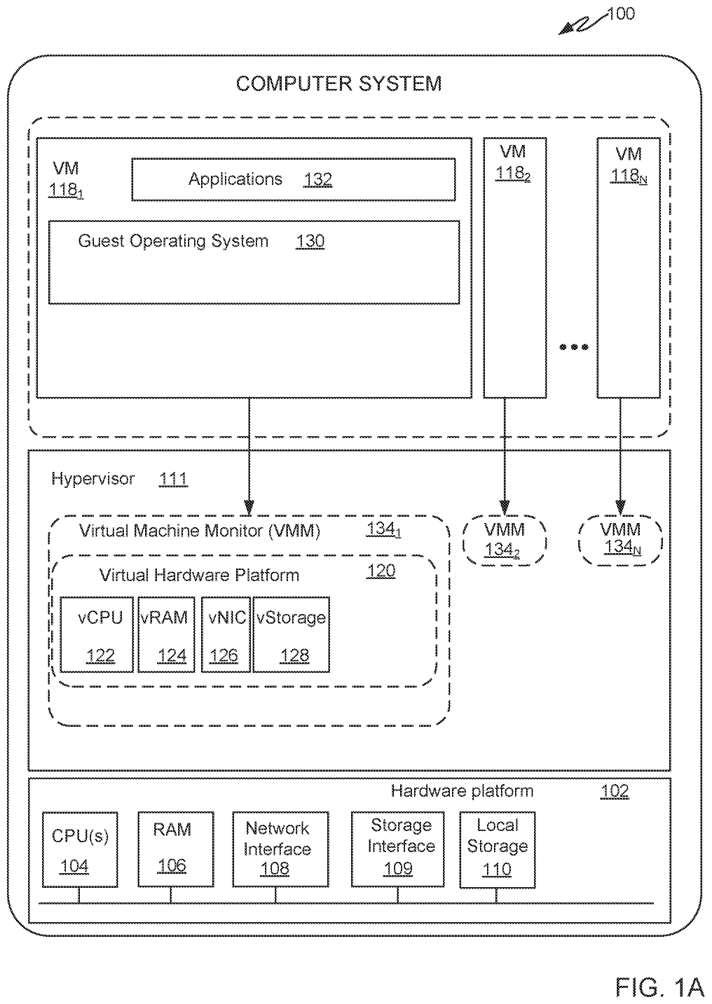

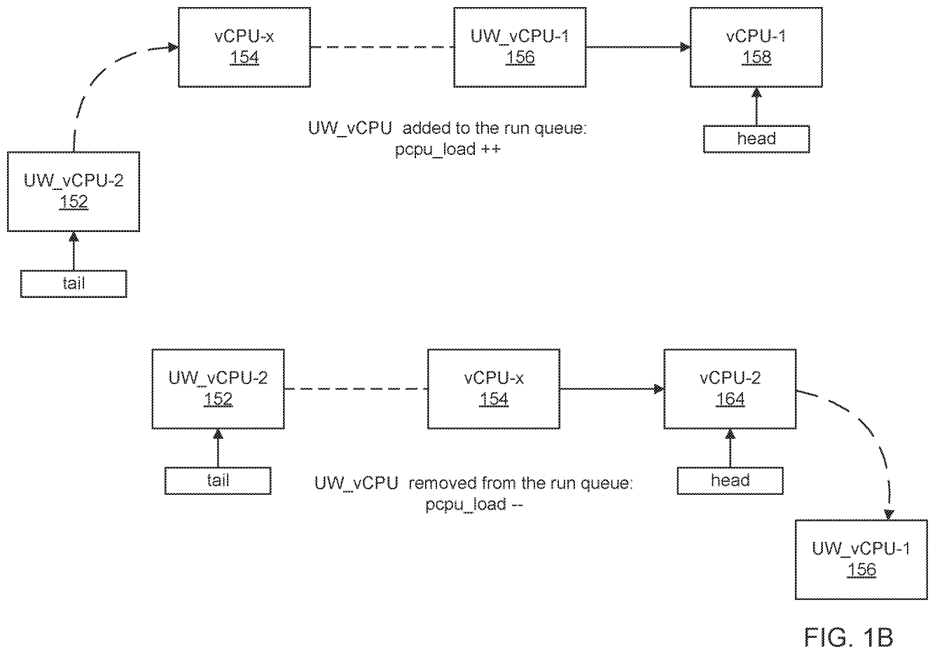

FIG. 1A depicts components of a computer system or server, in an embodiment. As is illustrated, computer system 100 hosts multiple virtual machines (VMs) 1181-118N that run on and share a common hardware platform 102. Hardware platform 102 includes conventional computer hardware components, such as one or more items of processing hardware such as central processing units (CPUs) 104, a random access memory (RAM) 106, one or more network interfaces 108, a storage interface 109, and local storage 110.

A virtualization software layer, referred to hereinafter as a hypervisor, is installed on top of hardware platform 102. Hypervisor 111 makes possible the concurrent instantiation and execution of one or more VMs 1181-118N. The interaction of a VM 118 with hypervisor 111 is facilitated by corresponding virtual machine monitors (VMMs) 134. Each VMM 134₁-134_{N} is assigned to and monitors a corresponding VM 1181-118N. In one embodiment, hypervisor 111 may be a hypervisor implemented as a commercial product in VMware's vSphere® virtualization product, available from VMware Inc. of Palo Alto, CA. In an alternative embodiment, hypervisor 111 runs on top of a host operating system which itself runs on hardware platform 102. In such an embodiment, hypervisor 111 operates above an abstraction level provided by the host operating system.

After instantiation, each VM 1181-118N encapsulates a physical computing machine platform that is executed under the control of hypervisor 111. Virtual devices of a VM 118 are embodied in a virtual hardware platform 120, which is comprised of, but not limited to, a virtual CPU (vCPU) 122, a virtual random access memory (vRAM) 124, a virtual network interface adapter (vNIC) 126, and virtual storage (vStorage) 128. Virtual hardware platform 120 supports the installation of a guest operating system (guest OS) 130, which is capable of executing applications 132. Examples of a guest OS 130 include any of the well-known commodity operating systems, such as the Microsoft Windows® operating system, the Linux® operating system, and the like.

It should be recognized that the various terms, layers, and categorizations used to describe the components in FIG. 1A may be referred to differently without departing from their functionality or the spirit or scope of the disclosure. For example, each VMM 134₁-134_{N} may be considered to be a component of its corresponding virtual machine since each VMM 1341-134N includes the hardware emulation components for the virtual machine. For example, the conceptual layer described as virtual hardware platform 120 is included in the VMM 1341. Alternatively, each VMM 134₁-134_{N} may be considered separate virtualization components between VM 118₁-118_{N} and hypervisor 111 since there exists a separate VMM for each instantiated VM. Further, though certain embodiments are described with respect to VMs, the techniques described herein may similarly be applied to other types of virtual computing instances, such as containers.

FIG. 1B is a conceptual diagram that depicts updates made to a run queue maintained by a kernel of hypervisor 111 for a particular physical CPU (pCPU), according to an embodiment. The run queue keeps track of the number of vCPUs 154, 156, 158 ready and waiting for the pCPU assignment by the kernel. The value pcpu load is an integer that indicates the number of vCPUs enqueued on the run queue for (and thus waiting for) the pCPU. A large positive number indicates a high demand for the pCPU. When a vCPU is enqueued onto the run queue and waiting for pCPU assignment by the kernel, the value pcpu_load is incremented by one, and when a vCPU is dequeued from the run queue (e.g., as a result of the pCPU assignment by the kernel), the value pcpu load is decremented by one. FIG. 1B depicts a user world (UW) vCPU (UW_vCPU-2 152) being added to the run queue, as a result of which UW_vCPU-2 152 is at the tail of the run queue, and a UW vCPU (UW_vCPU-1 156) being removed from the run queue, as a result of which vCPU-2 164 is at the head of the run queue.

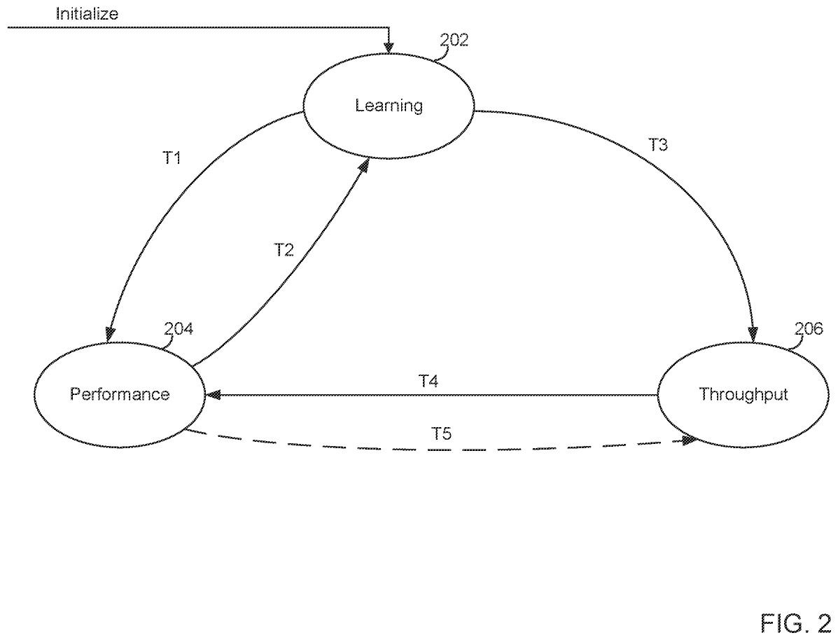

FIG. 2 depicts a state diagram illustrating different controlling states for executing an idling instruction for a VM and transitions among them, according to an embodiment. In the embodiments, the mwait instruction is given as an example of the idling instruction. As described above, the mwait instruction works in concert with a monitor instruction, which arms an address range of memory for specific events. A processor executing the mwait instruction transitions into an optimized state and wakes up from the optimized state when one of the specified events or a store operation occurs in the address range armed by the monitor instruction.

The different controlling states are learning 202, performance 204, and throughput 206. Each of these states controls how an mwait instruction that is encountered in an instruction stream of a VM is to be executed. In the learning state, the mwait instruction is executed in the monitor (e.g., the VMM), and mwait data, which includes data about the execution of the mwait instruction, is updated. In the embodiments described herein, mwait data includes #mwaits (which counts the number of times the mwait instruction is executed for the VM) and currAve (which keeps track of the average idle time of a virtual CPU when the mwait instruction is executed by the virtual CPU). In one embodiment, currAve keeps track of an exponentially weighted moving average (EWMA) of the idle time of the virtual CPU when the mwait instruction is executed for the virtual CPU. In the throughput state, the execution of the mwait instruction is emulated, and the mwait data is updated. In the performance state, the mwait instruction is executed in a virtual CPU of the VM.

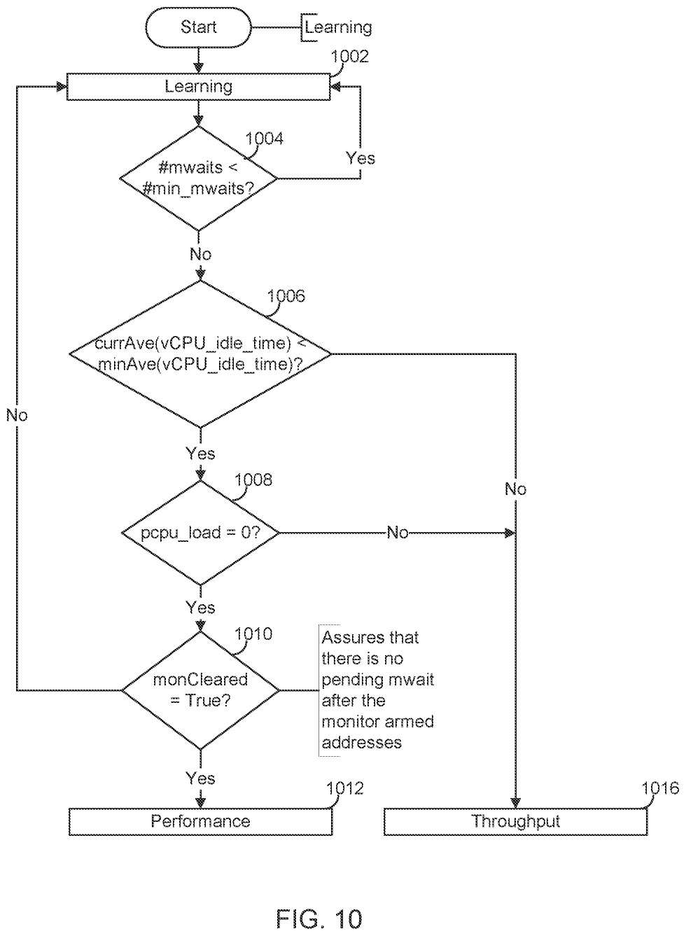

After initialization, the controlling state for executing the mwait instruction for the VM is the learning state. As part of the initialization, #mwaits and currAve, are set to zero, and the monitor instruction that arms an address range of memory for specific events is executed. Transitions to the other states from the learning state are depicted as T1, T2, T3, T4, and T5 in FIG. 2. These transitions depend on the mwait data and various other factors including the load on the physical CPU to which the virtual CPU is assigned, and are further described below with reference to FIGS. 10-12.

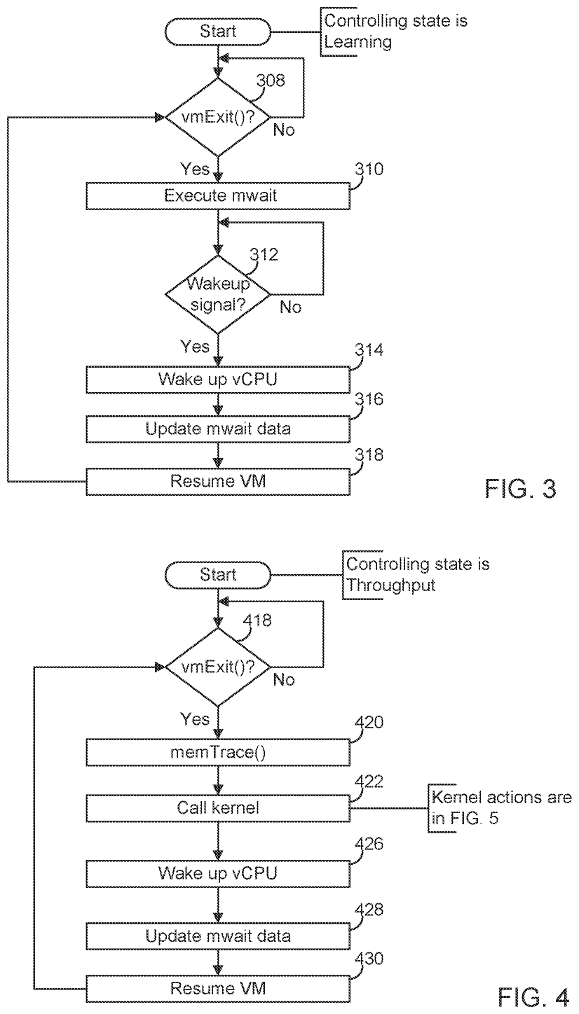

FIG. 3 depicts a flow of operations of the monitor when the mwait instruction is executed in a virtual CPU of the VM, and the controlling state is the learning state. In step 308, the VM pauses and hands control over to the monitor. This step is depicted as vmExit( )in FIG. 3. In one embodiment, to enable vmExit( )upon execution of the mwait instruction, the physical CPU is configured to trap the execution of the instruction as a privileged instruction. In step 310, the monitor performs a native execution of the mwait instruction on behalf of the VM. In step 312, the monitor awaits a wakeup signal from a physical CPU that is assigned to the virtual CPU. The physical CPU sends the wakeup signal to the virtual CPU in response to a wakeup event, e.g., an occurrence of one of the specified events or a store operation in the address range armed by the monitor instruction. In response to the wake-up signal, the monitor wakes up the virtual CPU of the VM in step 314. In step 316, the monitor updates the mwait data for the VM. In particular, #mwaits is incremented by one, and currAve is updated with the amount of time that the virtual CPU was idling. In step 318, the monitor resumes the virtual machine that paused, as a result of which the virtual CPU of the VM resumes execution of instructions.

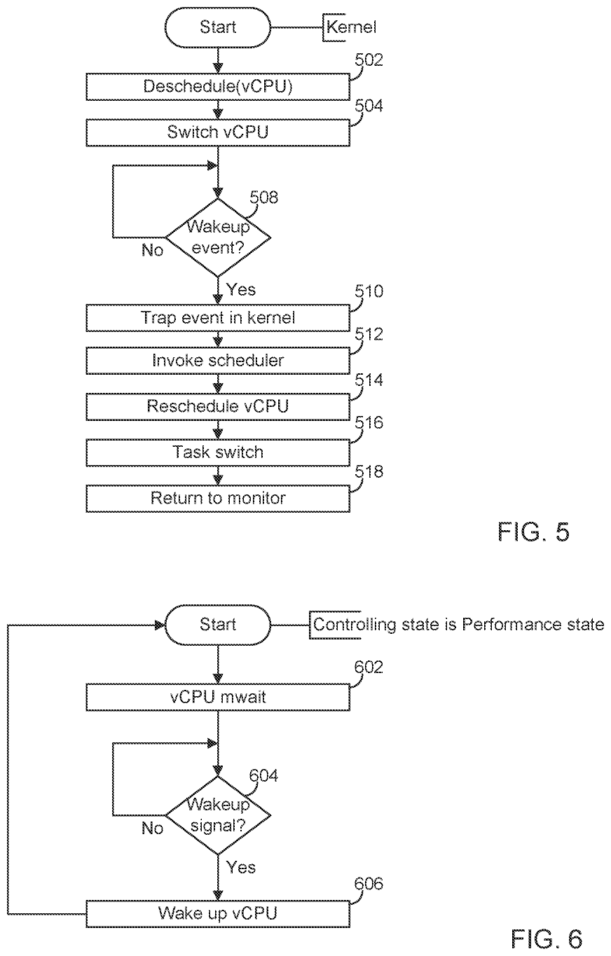

FIG. 4 depicts a flow of operations of the monitor when the mwait instruction is executed in a virtual CPU of the VM, and the controlling state is the throughput state. In the throughput state, the monitor and the kernel of hypervisor 111 cooperate to emulate the execution of the mwait instruction so that the physical CPU assigned to the virtual CPU can be rescheduled. In step 418, a vmExit( )is performed in which the VM pauses and hands control over to the monitor. In step 420, the monitor performs a memory trace operation (memTrace( ) to create a write-protected memory page. In step 422, the monitor calls the kernel to perform the steps depicted in FIG. 5. When the kernel returns control to the monitor, the monitor in step 426 wakes up the virtual CPU of the VM, and in step 428, updates the mwait data for the VM. In particular, #mwaits is incremented by one, and currAve is updated with the amount that the virtual CPU was idling. In step 430, the monitor resumes the virtual machine that paused, as a result of which the virtual CPU of the VM resumes execution of instructions.

FIG. 5 depicts a flow of operations of the kernel when the monitor calls the kernel in step 422. In step 502, the kernel deschedules the virtual CPU from the physical CPU to which it was assigned. In step 504, the kernel selects another virtual CPU to resume instructions after the mwait instruction. In step 508, the kernel awaits a wakeup event, which is a write to the previously established write-protected memory page (see step 420). When the event occurs, it is trapped in the kernel in step 510. In step 512, the kernel invokes its CPU scheduler, and in step 514 reschedules the virtual CPU that was selected in step 504. In step 516, the kernel performs a task switch to transfer the state of the descheduled virtual CPU to the rescheduled virtual CPU. Then, in step 518, the kernel returns control to the monitor.

FIG. 6 depicts a flow of operations of a virtual CPU when the mwait instruction is executed in a virtual CPU of the VM, and the controlling state is the performance state. In step 602, the virtual CPU natively executes the mwait instruction. In one embodiment, to enable this, the physical CPU is configured to permit native execution of the instruction at the privilege level assigned to the guest operating system. In step 604, the virtual CPU awaits a wakeup signal from a physical CPU that is assigned to the virtual CPU. The physical CPU sends the wakeup signal to the virtual CPU in response to a wakeup event, e.g., an occurrence of one of the specified events or a store operation in the address range armed by the monitor instruction. In step 606, the virtual CPU wakes up to execute instructions subsequent to the mwait instruction for the virtual machine.

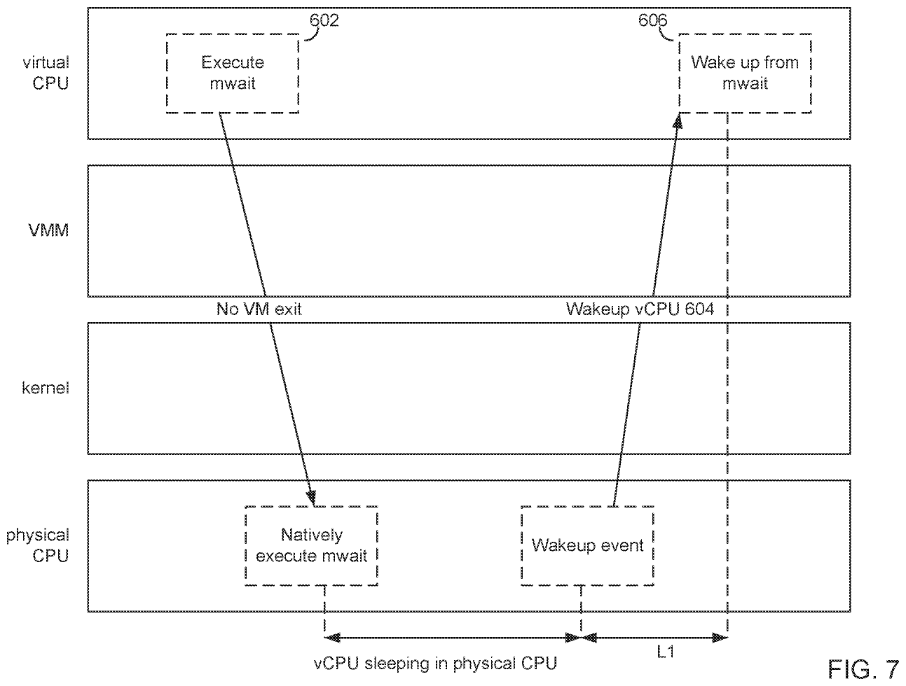

FIG. 7 depicts graphically the execution of the mwait instruction when the controlling state is the performance state. As depicted, the virtual CPU executes an mwait instruction (step 602 in FIG. 6), and the physical CPU to which the virtual CPU is assigned executes the mwait instruction natively. While the virtual CPU and physical CPU are sleeping, a wakeup event (such as writing to the address range of memory set by the monitor instruction) causes the physical CPU to send a wakeup signal to the virtual CPU (step 604 in FIG. 6). Thereafter, the virtual CPU executes the next instruction after the mwait instruction (step 606 in FIG. 6). The wakeup latency in this procedure is depicted as L1.

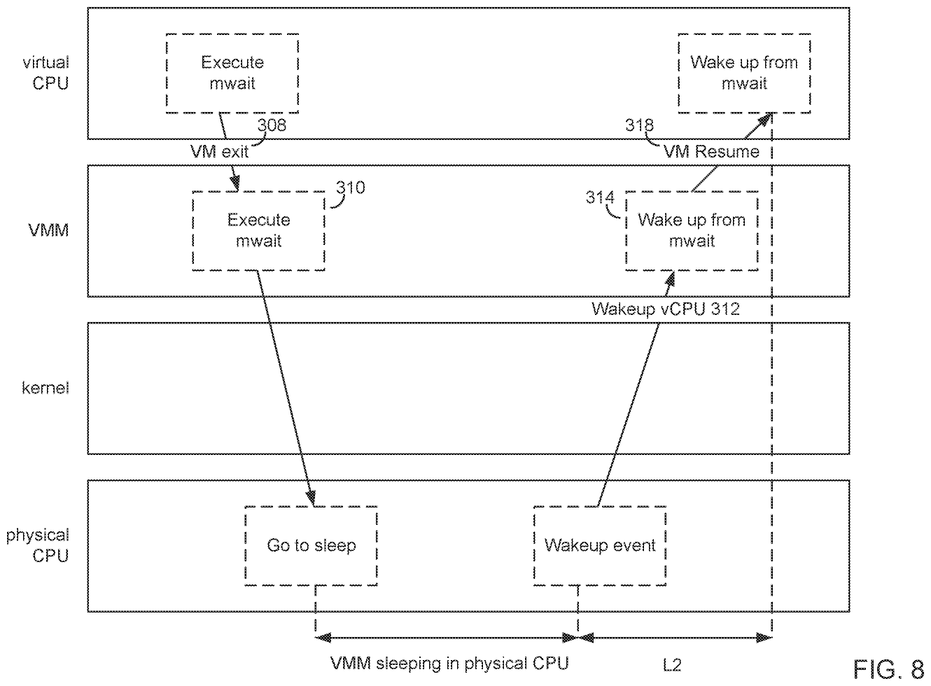

FIG. 8 depicts graphically the execution of the mwait instruction when the controlling state is the learning state. As depicted, the virtual CPU executes an mwait instruction, but an exit from the virtual machine occurs (step 308 in FIG. 3), trapping the execution of the instruction in the monitor. The monitor then natively executes the mwait instruction instead (step 310 in FIG. 3). As a result, the physical CPU to which the virtual CPU is assigned is idled, awaiting a wakeup event. Upon receiving the wakeup event (e.g., an occurrence of one of the specified events or a store operation in the address range armed by the monitor instruction), the physical CPU sends a wakeup signal to the virtual CPU (step 312 in FIG. 3) to wake up the virtual CPU. Then, the monitor wakes up the virtual CPU (step 314 in FIG. 3) and resumes the virtual machine (step 318 in FIG. 3) to execute the next instruction after the mwait instruction. The wakeup latency in this procedure is L2, which is greater than L1 because the monitor is involved.

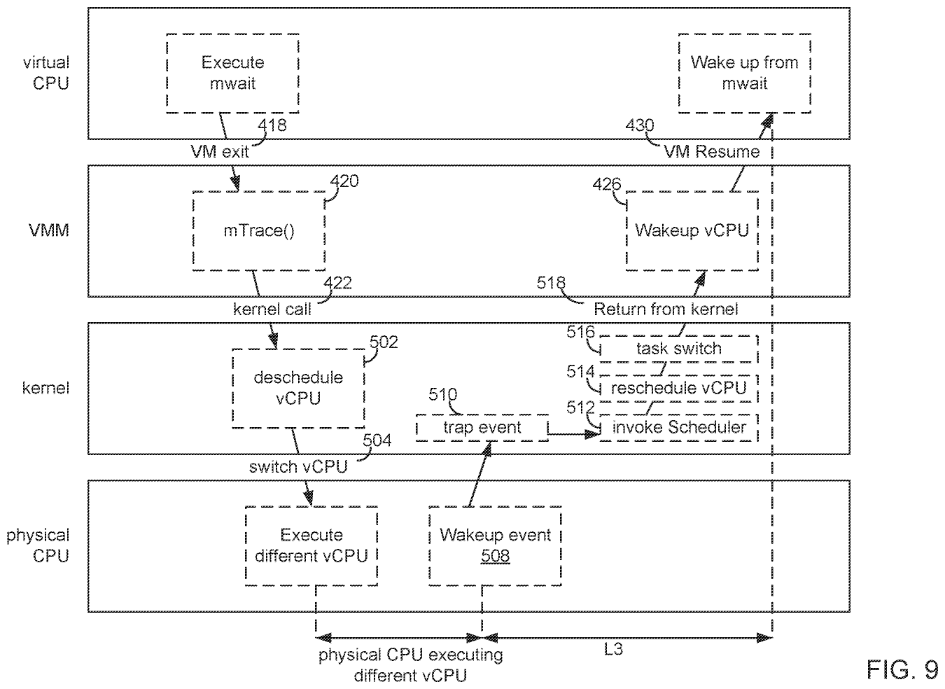

FIG. 9 depicts graphically the execution of the mwait instruction when the controlling state is the throughput state. As depicted, the virtual CPU executes an mwait instruction, but an exit from the virtual machine to the monitor occurs instead (step 418 in FIG. 4). After the exit, the monitor installs a memory trace as described above (step 420 in FIG. 4) and passes control to the kernel (step 422 in FIG. 4).

After control is passed to the kernel, the kernel deschedules the virtual CPU (step 502 in FIG. 5) so that the physical CPU to which the virtual CPU was assigned can be reassigned to a different virtual CPU. After the descheduling, the kernel selects another virtual CPU to resume instructions after the mwait instruction (step 504 in FIG. 5). Upon receiving a wakeup event, e.g., a memory write to the protected page (step 508 in FIG. 5), the kernel traps the event in step 510, invokes the scheduler (step 512 in FIG. 5) to reschedule the virtual CPU that the kernel selected to resume instructions after the mwait instruction (step 514 in FIG. 5), performs a task switch to transfer the state of the descheduled virtual CPU to the rescheduled virtual CPU (step 516 in FIG. 5), and returns control to the monitor (step 518 in FIG. 5).

After control is returned to the monitor, the monitor wakes up the virtual CPU (step 426 in FIG. 4) and resumes the virtual machine (step 430 in FIG. 4) to execute the next instruction after the mwait instruction. The wakeup latency in this procedure is L3, which is greater than L2 because the monitor and the kernel are both involved in executing the mwait instruction (through emulation).

FIG. 10 depicts a flow of operations for transitioning from the learning state to the performance state or to the throughput state, according to an embodiment. In step 1002, the controlling state is the learning state in which the monitor executes the mwait instruction on behalf of the virtual CPU. As determined in step 1004, if the number of executions of the mwait instruction is less than a minimum number (#min_mwaits), then the learning state persists.

If the average idle time (currAve) of the virtual CPU is less than a minimum time (minAve) as determined in step 1006 and the value of pcpu load of the physical CPU to which the virtual CPU is assigned is equal to zero as determined in step 1008, the flow proceeds to step 1010, where it is checked if there is any monitor instruction in process. If there is none (monCleared =True), then the monitor transitions the controlling state from the learning state to the performance state in step 1012. This transition is depicted as T1 in FIG. 2.

If the average idle time (currAve) of the virtual CPU is greater than or equal to the minimum time as determined in step 1006 or if the value of pcpu_load is greater than zero as determined in step 1008, then the monitor transitions the controlling state from the learning state to the throughput state in step 1016. This transition is depicted as T3 in FIG. 2.

Thus, if the demand for the physical CPU to which the virtual CPU is assigned is low (pcpu_load=0) and the average idle time of the virtual CPU is low (currAve<minAve), then a transition to the performance state occurs, thereby improving wakeup latency of the virtual CPU executing the mwait instruction. On the other hand, if either the demand for the physical CPU to which the virtual CPU is assigned is high (pcpu_load>0) or the average idle time of the virtual CPU is high (currAve≥minAve), then a transition to the throughput state occurs, thereby improving physical CPU usage.

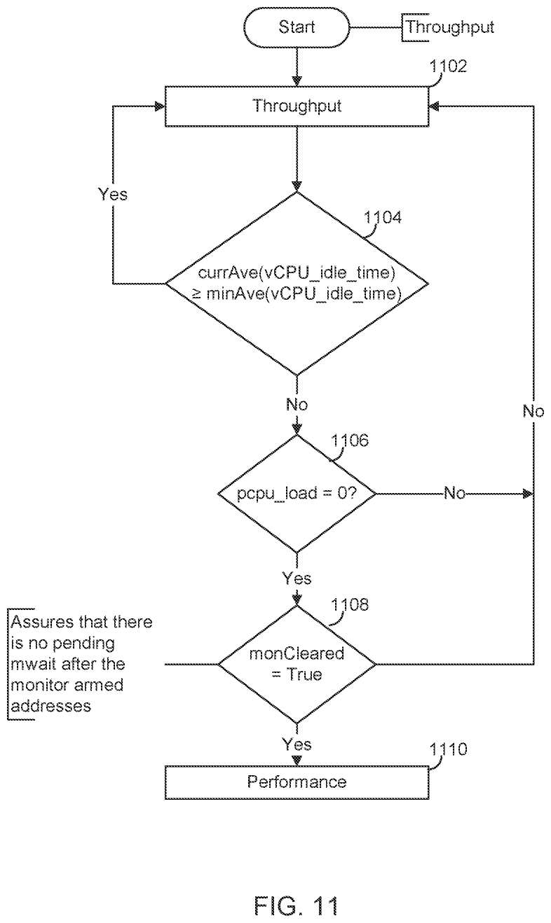

FIG. 11 depicts a flow of operations for transitioning from the throughput state to the performance state, according to an embodiment. In step 1102, the controlling state is the throughput state in which state the execution of the mwait instruction is emulated. The controlling state persists in the throughput state while the average idle time (currAve) of the virtual CPU is greater than or equal to the minimum time (minAve). However, if the average idle time (currAve) of the virtual CPU falls below the minimum time (minAve) as determined in step 1104, and the demand for the physical CPU becomes low (pcpu_load=0) as determined in step 1106, the system either transitions to the performance state in step 1110 when there is no pending monitor instruction (step 1108, Yes) or persists in the throughput state (step 1108, No).

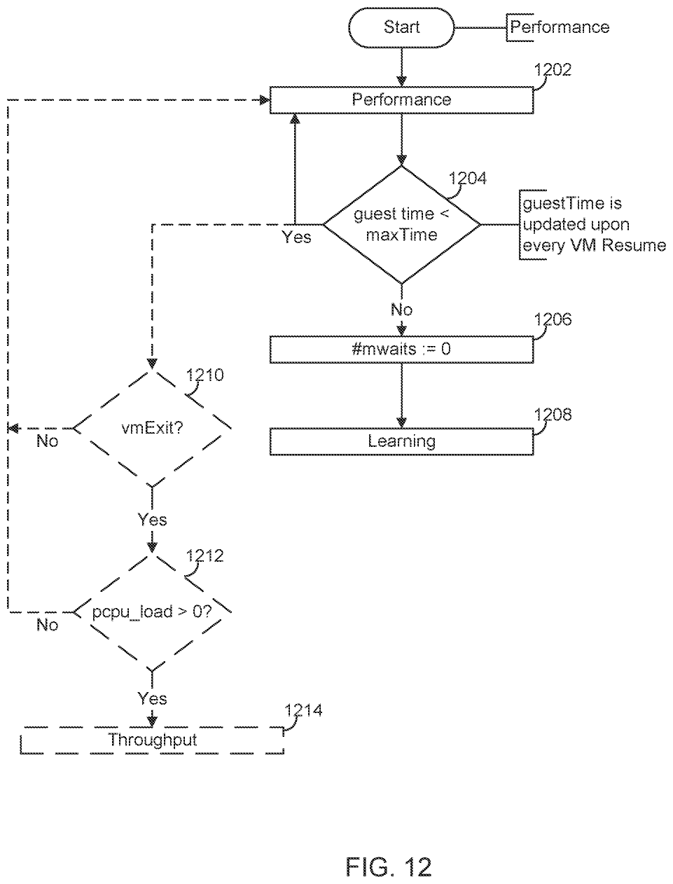

FIG. 12 depicts a flow of operations for transitioning from the performance state to the learning state and optionally to the throughput state, according to an embodiment. In step 1202, the controlling state is the performance state in which the mwait instruction of a virtual CPU is executed natively in the physical CPU to which the virtual CPU is assigned. The controlling state persists in the performance state as long as the time spent in the VM (guest time) is less than a prescribed maximum time (maxTime) as determined in step 1204. However, if the guest time exceeds the prescribed maximum time, the number of executions of the mwait instruction is reset to zero in step 1206, and the controlling state transitions to the learning state in step 1208 to enable the monitor to update the mwait data to account for any changes in the conditions for operating the VM.

Optionally, as depicted in dashed lines in FIG. 12, before the guest time exceeds the prescribed maximum time as determined in step 1204, if there is an exit from the VM as determined in step 1210, the value of pcpu load to which the virtual CPU of the VM is assigned is checked in step 1212. If the value is positive (step 1212, Yes), the controlling state transitions from the performance state to the throughput state in step 1214. This option may improve the computer system's ability to respond to changes in the values of pcpu_load and provide better resource management.

In yet another option, which is not depicted in FIG. 12, if the guest time exceeds the prescribed maximum time as determined in step 1204, instead of executing step 1206, the value of pcpu load to which the virtual CPU of the VM is assigned is checked. If the value is positive, the controlling state transitions from the performance state to the throughput state in step 1214. If the value is zero, steps 1206 and 1208 are executed. This option may improve performance because it stays in the performance state longer than the previous option but at the cost of resource management.

Certain embodiments as described above involve a hardware abstraction layer on top of a host computer. The hardware abstraction layer allows multiple contexts to share the hardware resource. These contexts are isolated from each other in one embodiment, each having at least a user application program running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application program runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers, each including an application program and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application program's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained only to use a defined amount of resources such as CPU, memory, and I/O.

Certain embodiments may be implemented in a host computer without a hardware abstraction layer or an OS-less container. For example, certain embodiments may be implemented in a host computer running a Linux® or Windows® operating system.

The various embodiments described herein may be practiced with other computer system configurations, including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer-readable media. The term computer-readable medium refers to any data storage device that can store data which can thereafter be input to a computer system. Computer-readable media may be based on any existing or subsequently developed technology for embodying computer programs in a manner that enables them to be read by a computer. Examples of a computer-readable medium include a hard drive, network-attached storage (NAS), read-only memory, random-access memory (e.g., a flash memory device), a CD (Compact Discs)—CD-ROM, a CDR, or a CD-RW, a DVD (Digital Versatile Disc), a magnetic tape, and other optical and non-optical data storage devices. The computer-readable medium can also be distributed over a network-coupled computer system so that the computer-readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method of improving performance of a computer system having a virtual machine running therein and executing an idling instruction, the method comprising:
determining by a virtualization software for the virtual machine, a state for controlling the execution of the idling instruction for a first virtual CPU;
when the controlling state is a first state, executing the idling instruction natively in a physical CPU assigned to the first virtual CPU and resuming execution of instructions after the idling instruction by the first virtual CPU when the physical CPU wakes up; and
when the controlling state is a second state, emulating execution of the idling instruction, the emulated execution including the steps of configuring a wakeup event, descheduling the first virtual CPU, and selecting a second virtual CPU to resume execution of the instructions after the idling instruction, and in response to the wakeup event, rescheduling the second virtual CPU, performing a task switch from the first virtual CPU to the second virtual CPU, and resuming execution of the instructions after the idling instruction by the second virtual CPU.

2. The method of claim 1, wherein
when the controlling state is a third state, executing the idling instruction natively in a monitor for the virtual machine.

3. The method of claim 2, wherein
when the controlling state is the second state, updating information about the execution of the idling instruction for the virtual CPU based on the emulated execution of the idling instruction, and
when the controlling state is the third state, updating information about the execution of the idling instruction for the virtual CPU based on the execution of the idling instruction natively in the monitor.

4. The method of claim 3, wherein the information about the execution of the idling instruction includes a number of times the idling instruction has been executed for the virtual CPU and an average idle time of the virtual CPU.

5. The method of claim 4, wherein
an initial state of the controlling state is the third state and the controlling state transitions from the third state to the first state or the second state based on at least the number of times the idling instruction has been executed for the virtual CPU and the average idle time of the virtual CPU.

6. The method of claim 5, wherein
the controlling state transitions from the third state to the first state or the second state further based on a run queue that contains a list of virtual CPUs waiting to use the first physical CPU.

7. The method of claim 6, wherein
the controlling state transitions from the first state to the third state when a time spent in the third state exceeds a maximum time.

8. The method of claim 6, wherein
the controlling state transitions from the second state to the first state when the average idle time of the virtual CPU is greater than or equal to a minimum time and a size of the run queue for the first physical CPU is zero.

9. A computer system having a virtual machine running therein, said computer system comprising:
one or more physical CPUs; and
a virtualization software for the virtual machine including a kernel that maintains a run queue for each of the physical CPUs, wherein the virtualization software is configured to:
determine a state for controlling the execution of an idling instruction for a virtual CPU of the virtual machine;
when the controlling state is a first state, execute the idling instruction natively in a physical CPU assigned to the first virtual CPU and resume execution of instructions after the idling instruction by the first virtual CPU when the physical CPU wakes up; and
when the controlling state is a second state, emulate execution of the idling instruction, the emulated execution including the steps of configuring a wakeup event, descheduling the first virtual CPU, and selecting a second virtual CPU to resume execution of the instructions after the idling instruction, and in response to the wakeup event, reschedule the second virtual CPU, perform a task switch from the first virtual CPU to the second virtual CPU, and resume execution of the instructions after the idling instruction by the second virtual CPU.

10. The computer system of claim 9, wherein the virtualization software is further configured to:
when the controlling state is a third state, execute the idling instruction natively in a monitor for the virtual machine.

11. The computer system of claim 10, wherein the virtualization software is further configured to:
when the controlling state is the second state, update information about the execution of the idling instruction for the virtual CPU based on the emulated execution of the idling instruction, and
when the controlling state is the third state, update information about the execution of the idling instruction for the virtual CPU based on the execution of the idling instruction natively in the monitor.

12. The computer system of claim 11, wherein the information about the execution of the idling instruction includes a number of times the idling instruction has been executed for the virtual CPU and an average idle time of the virtual CPU.

13. The computer system of claim 12, wherein
an initial state of the controlling state is the third state and the controlling state transitions from the third state to the first state or the second state based on at least the number of times the idling instruction has been executed for the virtual CPU and the average idle time of the virtual CPU.

14. The computer system of claim 13, wherein
the controlling state transitions from the third state to the first state or the second state further based on a run queue that contains a list of virtual CPUs waiting to use the first physical CPU.

15. The computer system of claim 14, wherein
the controlling state transitions from the first state to the third state when a time spent in the third state exceeds a maximum time.

16. The computer system of claim 14, wherein
the controlling state transitions from the second state to the first state when the average idle time of the virtual CPU is greater than or equal to a minimum time and a size of the run queue for the first physical CPU is zero.

17. A non-transitory computer-readable medium comprising instructions that are executable in a computer system having a virtual machine running therein and executing an idling instruction, to cause the computer system to carry out a method that comprises the steps of:
determining by a virtualization software for the virtual machine, a state for controlling the execution of the idling instruction for a first virtual CPU;
when the controlling state is a first state, executing the idling instruction natively in a physical CPU assigned to the first virtual CPU and resuming execution of instructions after the idling instruction by the first virtual CPU when the physical CPU wakes up; and
when the controlling state is a second state, emulating execution of the idling instruction, the emulated execution including the steps of configuring a wakeup event, descheduling the first virtual CPU, and selecting a second virtual CPU to resume execution of the instructions after the idling instruction, and in response to the wakeup event, rescheduling the second virtual CPU, performing a task switch from the first virtual CPU to the second virtual CPU, and resuming execution of the instructions after the idling instruction by the second virtual CPU.

18. The non-transitory computer-readable medium of claim 17, wherein the method further comprises the step of:
when the controlling state is a third state, executing the idling instruction natively in a monitor for the virtual machine.

19. The non-transitory computer-readable medium of claim 18, wherein the method further comprises the steps of:
when the controlling state is the second state, updating information about the execution of the idling instruction for the virtual CPU based on the emulated execution of the idling instruction, and
when the controlling state is the third state, updating information about the execution of the idling instruction for the virtual CPU based on the execution of the idling instruction natively in the monitor.

20. The non-transitory computer-readable medium of claim 19, wherein the information about the execution of the idling instruction includes a number of times the idling instruction has been executed for the virtual CPU and an average idle time of the virtual CPU.
